(19) United States
(12) Patent Application Publication
(10) Pub. No.: US 2004/0091311 A1
(43) Pub. Date: May 13, 2004

(54) Clip for pressing a heat sink tightly against a CPU surrounded by a stationary enclosure

(76) Inventor: Jen-Cheng Lin, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/290,164

(22) Filed: Nov. 8, 2002

(51) Int. Cl. B25G 3/18

(52) U.S. Cl. 403/322.4

(57) ABSTRACT

A clip for pressing a heat sink tightly against a central processing unit surrounded by a stationary enclosure includes a resiliently flexible beam with a downwardly-curved middle portion, a first arm integrally extending downward from a first end of the resiliently flexible beam, and a second arm having an upper end pivotally connected to a second end of the resiliently flexible beam. The arms have lower ends adapted to be engaged with the stationary enclosure in such a way that the resiliently flexible beam may be in a certain degree of flexion. The resiliently flexible beam has an inverted U-shaped cross section to provide the beam with an improved rigidity, so that the downwardly-curved middle portion of the resiliently flexible beam in the certain degree of flexion exerts an increased pressure upon the heat sink and presses the heat sink tightly against the central processing unit.

### BACKGROUND OF THE INVENTION

1. Field of the Invention

The present invention relates to a clip for pressing a heat sink against a CPU and, more particularly, to a clip for pressing a heat sink tightly against a CPU surrounded by a stationary enclosure.

2. Description of Related Art

A heat sink is required in a computer to absorb and dissipate heat generated by a CPU (central processing unit) during its operation. Usually, the dissipation benefits from a fan atop the heat sink and the absorption is achieved by pressing the heat sink directly against the CPU by means of one or more clips.

In the prior art, the clip is typically made of a resilient metal strap that has a middle portion for abutting the heat sink and a pair of arms for engaging with a stationary enclosure surrounding the CPU.

It has been found that the conventional clip can not press the heat sink against the CPU as tightly as necessary, since the middle portion of the clip is too flexible to exert a sufficient pressure upon the sink.

Therefore, it is an objective of the invention to provide a clip to mitigate and/or obviate the aforementioned problems.

### SUMMARY OF THE INVENTION

The object of the present invention is to provide a clip which can press a heat sink tightly against a CPU surround by a stationary enclosure.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a clip in accordance with the present invention;

FIG. 2 is an exploded perspective view, showing two clips of FIG. 1 to be used for pressing a heat sink tightly against a CPU surround by a stationary enclosure;

FIG. 3 is a perspective view, showing the two clips of FIG. 2 pressing the heat sink tightly against the CPU;

FIG. 4 is a transverse sectional view, showing the two clips of FIG. 2 pressing the heat sink tightly against the CPU;

FIG. 5 is a perspective view of a second embodiment of the clip in accordance with the present invention;

FIG. 6 is an exploded perspective view of the clip of FIG. 5;

FIG. 7 is a perspective view, showing the clip of FIG. 5 pressing the heat sink tightly against the CPU surround by the stationary enclosure;

FIG. 8 is an exploded perspective view of a third embodiment of the clip in accordance with the present invention to be used for pressing a heat sink tightly against a CPU surround by an alternative stationary enclosure;

FIG. 9 is a transverse sectional view, showing the clip of FIG. 8 pressing the heat sink tightly against the CPU surround by the alternative stationary enclosure; and

FIG. 10 is a perspective view, showing the clip of FIG. 8 pressing the heat sink tightly against the CPU surround by the alternative stationary enclosure.

### DETAILED DESCRIPTION OF THE PREFERRED EMBODIMENT

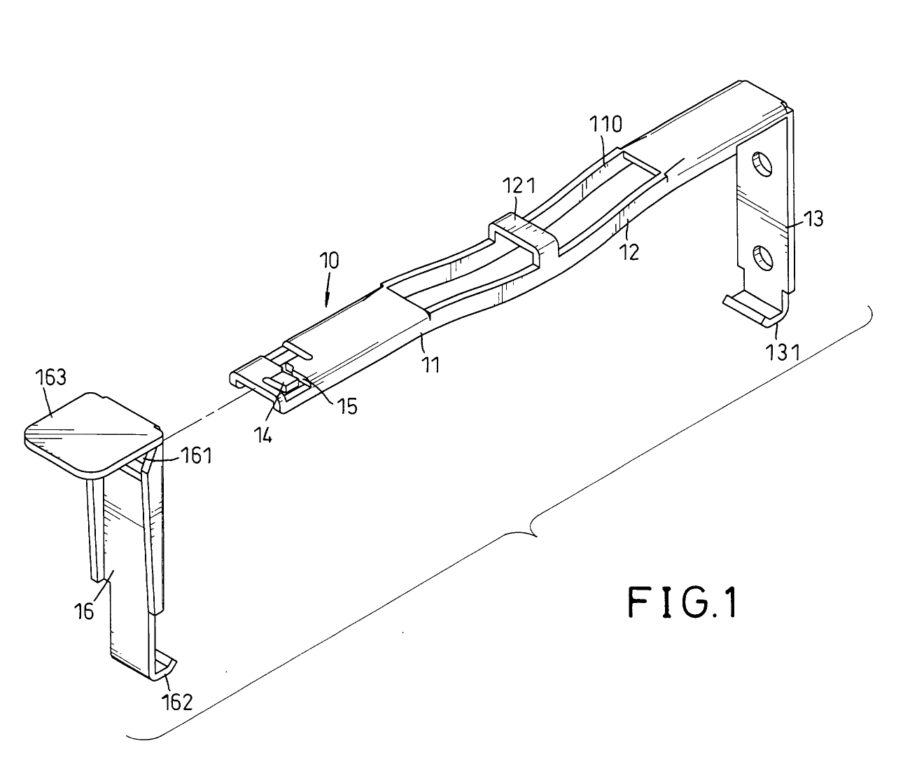

Referring to FIG. 1, a first embodiment of a clip (10) in accordance with the present invention includes a resiliently flexible beam (11) having a downwardly-curved middle portion, with a first arm (13) integrally extending downward from a first end of the beam (11) and a second arm (16) pivotally connected to a second end of the same beam (11). Each of the arms (13, 16) has a lower end formed with a hook (131, 162).

In the inventive clip (10), the resiliently flexible beam (11) has an inverted U-shaped cross section that provides the beam (11) with an improved rigidity. The beam (11) preferably has an elongated top opening (110) defined by a pair of side ribs (12), and a bridge (121) extending across the opening (110) and connecting the two ribs (12). Furthermore, a resilient flap (14) and a slot (15) are formed in the beam (11) at its second end.

The second arm (16), preferably formed with a laterally-extending top tab (163), defines a through-hole (161) adjacent to an upper end thereof. It is through the through-hole (161) that the second end of the resilient flexible beam (11) extends until the depressed resilient flap (14) recovers its shape and keeps the second arm (16) in the slot (15), thereby pivotally connecting the second arm (16) to the beam (11).

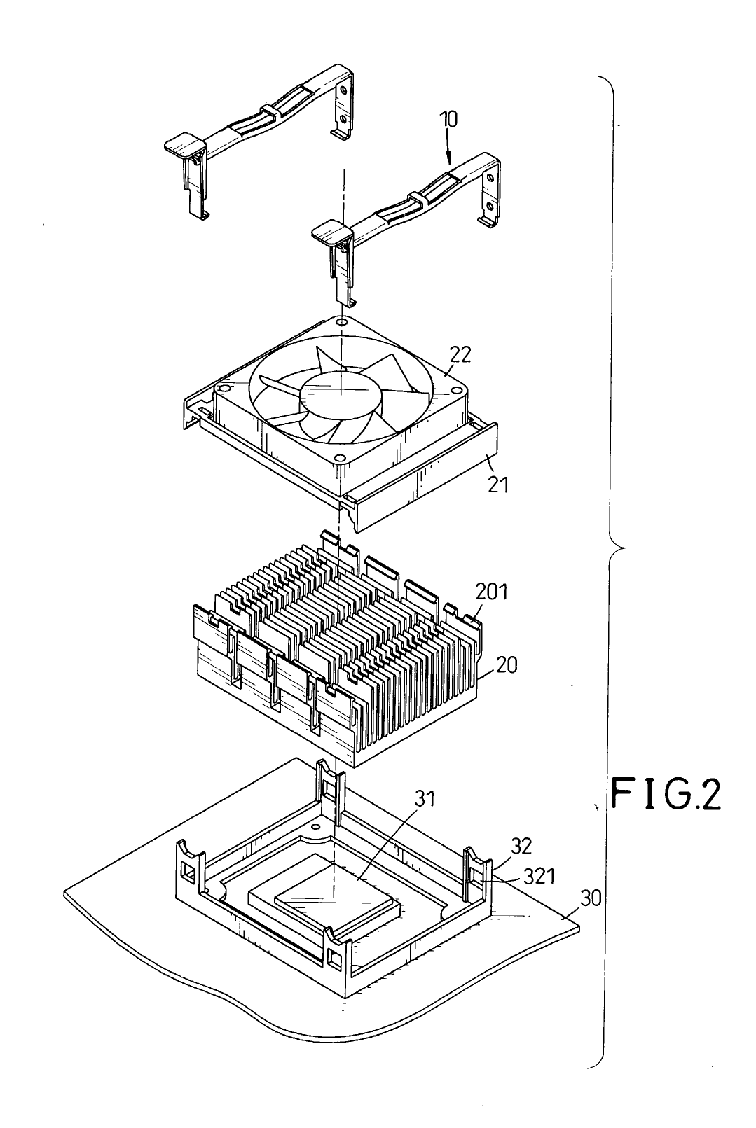

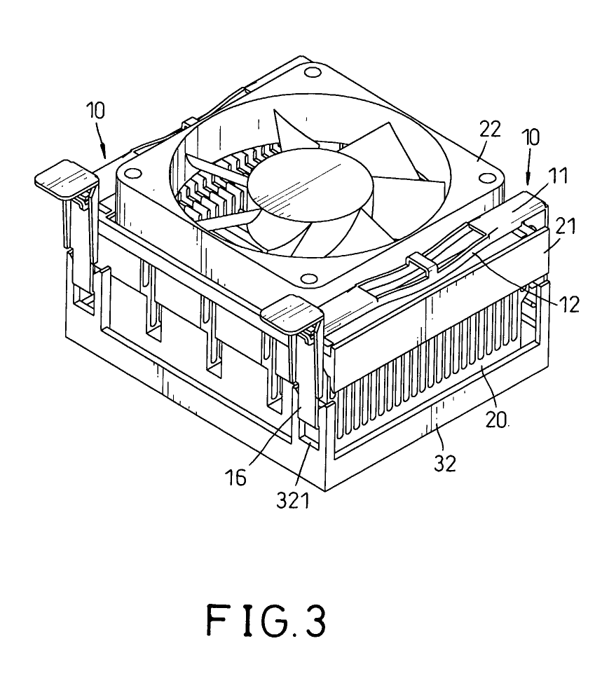

Referring to FIG. 2, the clip (10) is provided for pressing a heat sink (20) tightly against a Pentium® 4 CPU soldered to a circuit board (30), as well as for pressing a fan (22) tightly against the heat sink (20), as best shown in FIG. 3.

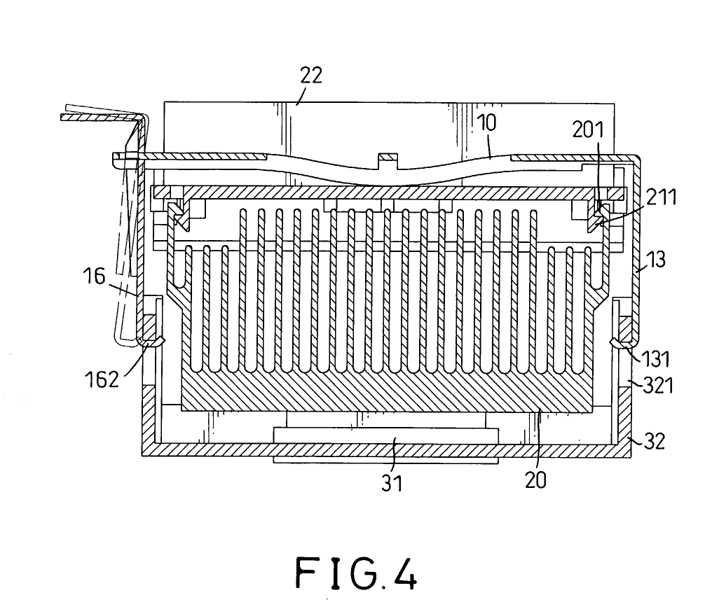

It is well known that the Pentium®4 CPU on any circuit board (30) is typically surrounded by a stationary enclosure (32) having a plurality of holes (321) defined therein. Additionally, the fan (22) generally has a pair of outwardly-extending flanges (21) formed with respective bottom hooks (211) engagable with top hooks (201) of the heat sink (20), as can be seen in FIG. 4.

Referring to FIGS. 3 and 4, the heat sink (20) can be positioned on the CPU by placing it into the stationary enclosure (32) after the bottom hooks (211) of the fan (22) are engaged with the top hooks (201) of the heat sink (20).

Either inventive clip (10) now can be applied to the enclosure (32), with its resilient flexible beam (11) laid on one of the flanges (21) and its hook (131) engaging with one of holes (321) of the enclosure (32). Then the top tab (163) of the second arm (16) is pressed down to move the hook (162) inward and downward, until this hook (162) is snapped into and engaged with the opposite hole (321) of the enclosure (32), as best shown in FIG. 4.

It is clear that the resiliently flexible beam (11, 51) is now in a certain degree of flexion since its downwardly-curved middle portion is supported on the flange (21) of the fan (22) while its both ends are pulled down by the two arms (13, 16). Because the resilient flexible beam (11) is provided with an improved rigidity resulted from its inverted U-shaped cross section as mentioned above, the inventive clip (10) will make the downwardly-curved middle portion of this beam (11) to exert an increased pursuer upon the heat sink (20) and press the heat sink (20) more tightly against the CPU (31), via the fan (22), than any other clip that is in the same degree of flexion but without increased rigidity.

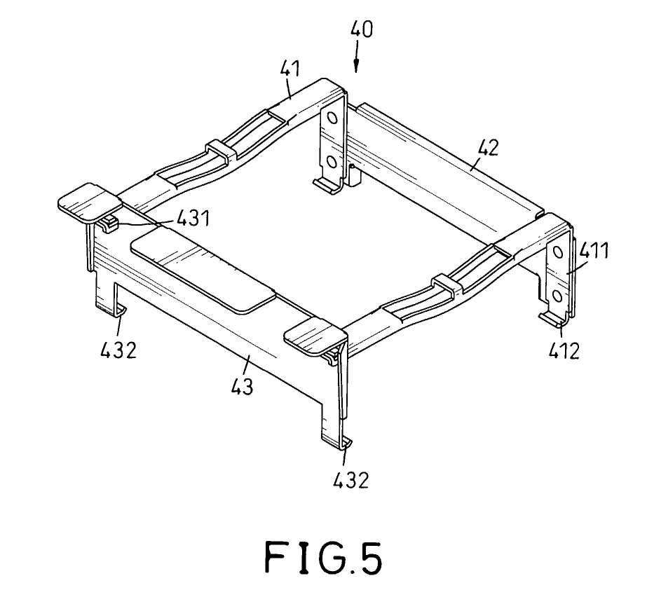

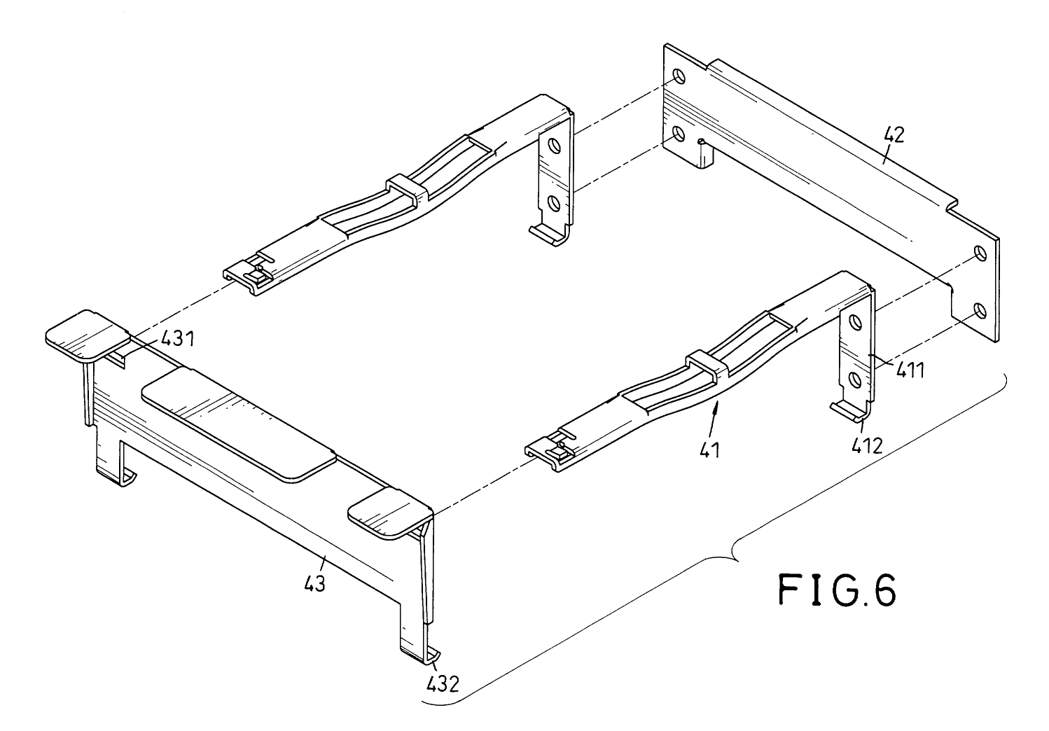

Referring to FIGS. 5 and 6, there is shown a second embodiment of the clip (40) in accordance with the present invention.

The clip (40) here includes a pair of resiliently flexible beams (41), each having the same configuration as in the first embodiment. In addition, a pair of first arms (411) integrally extend downward from first ends of the resiliently flexible beams (41) and are joined together by a connector (42).

Opposite to the connector (42) is a second arm (43) that defines a pair of through-holes (431) adjacent to an upper edge thereof, for the purpose of pivotally connecting the arm (43) to second ends of the beams (41) in the same manner as described in the first embodiment. These arms (411, 43) also have respective lower hooks (412, 432) formed at free ends thereof.

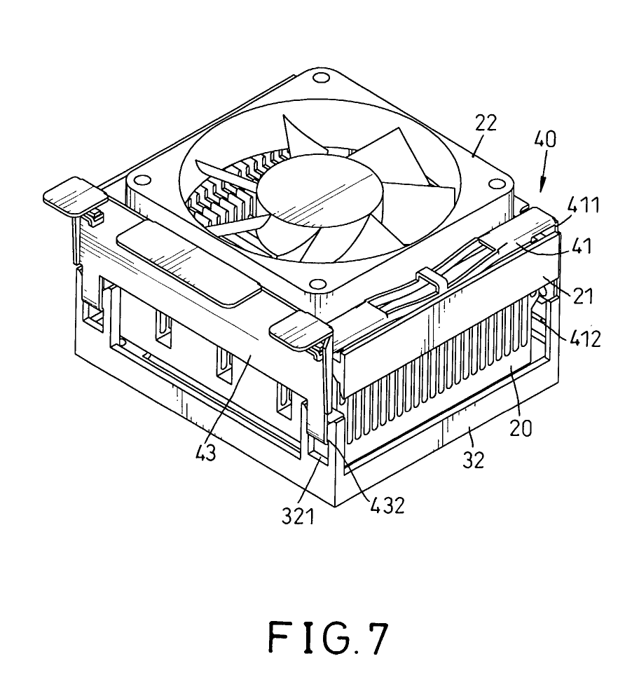

Referring to FIG. 7, the clip (40) is applied to the enclosure (32) by placing its two resilient flexible beams (41) on the flanges (21) of the fan (22) simultaneously before its hooks (412, 432) are engaged with respective holes (321) of the stationary enclosure (32). It is apparent that this clip (40) can also press the heat sink (20) tightly against the CPU (not shown in FIG. 7).

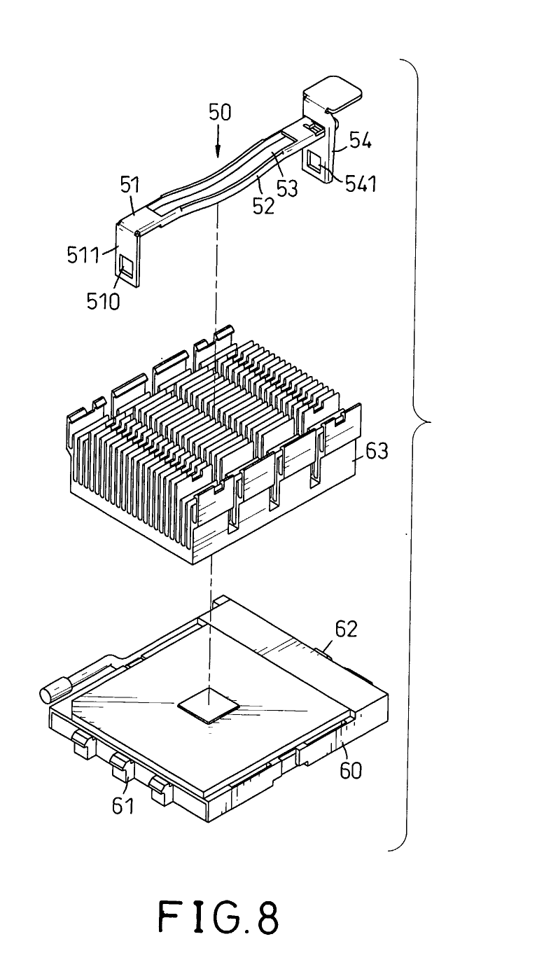

Referring to FIG. 8, there is shown a third embodiment of the clip (50) in accordance with the present invention. In this embodiment, the clip (50) has a configuration substantially similar to the one as mentioned in the first embodiment.

That is, the clip (50) includes a resiliently flexible beam (51) having an inverted U-shaped cross section, as well as a first arm (511) integrally extending downward from a first end of the beam (51), and a second arm (54) pivotally connected to a second end of the same beam (51) in the same manner in as described in the first embodiment. The beam (51) also has a downwardly-curved middle portion and an elongated top opening (53) defined by a pair of side ribs (52), except that the arms (511, 54) have lower ends formed with a respective apertures (510, 541) rather than hooks. This clip (50) is provided for pressing a heat sink (63) tightly against a CPU (not numbered) surrounded by a stationary enclosure (60) that has a pair of opposed protrusions (61, 62) projecting therefrom.

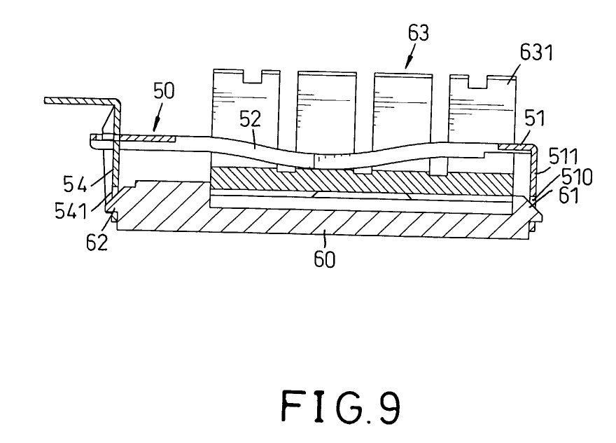

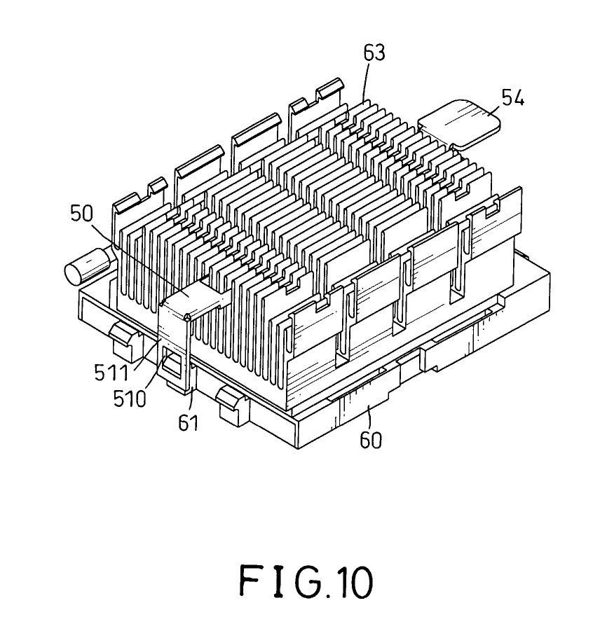

Referring to FIGS. 9 and 10, the clip (50) is applied to the enclosure (60) by placing its resiliently flexible beam (51) directly on the heat sink (63), with some fins (631) of the sink (63) extending through the elongated top opening (53) of the beam (51).

As soon as the clip (50) is pressed down and the apertures (510, 541) of the arms (511, 54) are snapped onto and engaged with the protrusions (61, 62) of the stationary enclosure, the downwardly-curved portion of the beam (51) will press the heat sink (63) tightly against the CPU.

From the above description, it is apparent that the invention has the advantage of pressing the heat sink (20, 63) more tightly against the CPU than a prior art clip in the same degree of flexion.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clip (10, 50) for pressing a heat sink (20, 63) tightly against a central processing unit (31) surrounded by a stationary enclosure (32, 60), comprising:
a resiliently flexible beam (11, 51) having a first end and a second end, said resiliently flexible beam (11, 51) being formed with a downwardly-curved middle portion between said ends;
a first arm (13, 511) integrally extending downward from said first end of said resiliently flexible beam (11, 51);
a second arm (16, 54) having an upper end pivotally connected to said second end of said resiliently flexible beam (11, 51);
said arms (13, 16; 511, 54) having lower ends adapted to be engaged with said stationary enclosure (32, 60) in such a way that said resiliently flexible beam (11, 51) may be in a certain degree of flexion; and
wherein said resiliently flexible beam (11, 51) has an inverted U-shaped cross section to provide said beam (11, 51) with an improved rigidity, whereby said downwardly-curved middle portion of said resiliently flexible beam (11, 51) in said certain degree of flexion may exert an increased pressure upon said heat sink (20, 63) and press said heat sink (20, 63) tightly against said central processing unit (31).

2. The clip as claimed in claim 1, wherein said resiliently flexible beam (11, 51) has an elongated opening (110, 53) defined in a top thereof.

3. The clip as claimed in claim 2, wherein said resiliently flexible beam (11, 51) has a bridge (121) extending across said opening (110, 53).

4. The clip as claimed in claim 1, wherein said second arm (16, 54) defines a through-hole (161) adjacent to said upper end, and wherein said resiliently flexible beam (11, 51) is formed at said second end with a slot (15) and a resilient flap (14) for keeping said second arm (16, 54) in said slot (15) after said second end of said resilient flexible beam (11, 51) has extend through said through-hole (161, 431) of said second arm (16, 54).

5. The clip as claimed in claim 1, wherein said stationary enclosure (32) has a plurality of holes (321) defined therein, and wherein said arms (13, 16) have lower ends formed with respective hooks (131, 162) adapted to be engaged with said holes (321), thereby attaching said lower ends of said arms (13, 16) to said stationary enclosure (32, 60).

6. The clip as claimed in claim 1, wherein said stationary enclosure (60) has a pair of opposed protrusions (61, 62) projecting therefrom, and wherein said arms (54, 511) have lower ends formed with respective apertures (541, 510) adapted to be engaged with said protrusions (61, 620), thereby attaching said lower ends of said arms (54, 511) to said stationary enclosure (60).

7. A clip (40) for pressing a heat sink (20) tightly against a central processing unit (31) surrounded by a stationary enclosure (32), comprising:
a pair of resiliently flexible beams (41) each having a first end and a second end, each of said resiliently flexible beams (41) being formed with a downwardly-curved middle portion between said ends thereof;
a pair of first arms (411) integrally extending downward from said first ends of said resiliently flexible beams (41) respectively, said first arms (411) being joined together by a connector (42);
a second arm (43) having an upper edge (43) pivotally connected to said second ends of said resiliently flexible beams (41);
said arms (411, 43) having lower hooks (412, 432) adapted to be attached to said stationary enclosure (32, 60) in such a way that said resiliently flexible beams (41) may be in a certain degree of flexion; and
wherein each of said resiliently flexible beam (41) has an inverted U-shaped cross section to provide said resiliently flexible beam (41) with an improved rigidity, whereby said downwardly-curved middle portions of said resiliently flexible beams (41) in said certain degree of flexion may exert an increased pressure upon said heat sink (20) and press said heat sink (20, 63) tightly against said central processing unit (31).

8. The clip as claimed in claim 7, wherein each of said resiliently flexible beams (41) has an elongated opening defined in a top thereof.

9. The clip as claimed in claim 8, wherein each of said resiliently flexible beams (41) has a bridge extending across said opening.

10. The clip as claimed in claim 7, wherein said second arm (43) defines a pair of through-hole (431) adjacent to said upper edge, and wherein each of said resiliently flexible beams (41) is formed at said second end with a slot and a resilient flap for keeping said second arm (43) in said slot (15) after said second ends of said resilient flexible beams (41) have extend through said through-holes (431) of said second arm (43).
